(19) United States
(12) Patent Application Publication
(10) Pub. No.: US 2026/0195597 A1
(43) Pub. Date: Jul. 9, 2026

(54) SLOPE STABILITY MONITORING SYSTEM FOR SPOIL GROUNDS

(71) Applicant: Chang'an University, Xi'an (CN)

(72) Inventors: Wei Xiao, Xi'an (CN); Yi Song, Xi'an (CN)

(21) Appl. No.: 19/432,028

(22) Filed: Dec. 23, 2025

(30) Foreign Application Priority Data
Jan. 6, 2025 (CN) 202510016272.9

(51) Int. Cl. G06N 3/084; E21F 17/18; G06F 17/15; G06F 17/16; G06F 18/21; G06F 18/2135; G06N 3/0475

(52) U.S. Cl. CPC G06N 3/084; E21F 17/18; G06F 17/15; G06F 17/16; G06F 18/2135; G06F 18/217; G06N 3/0475

(57) ABSTRACT

A slope stability monitoring system for spoil grounds includes: a data collection module, responsible for collecting deformation data of a slope in real time through various sensors, and acquiring macro information of the slope using aerial images and digital elevation images; and a data transmission module, responsible for transmitting the collected data to a data processing center in real time using the Internet of Things (IoT) technology. The data processing center includes a data processing and analysis module, an early warning and decision support module and a user interaction module.

### CROSS-REFERENCE TO RELATED APPLICATION

This application claims priority of Chinese Patent Application No. 202510016272.9, filed on Jan. 6, 2025, the entire contents of which are incorporated herein by reference.

### TECHNICAL FIELD

The present disclosure relates to the technical field of safety monitoring, and in particular to a slope stability monitoring system for spoil grounds.

### BACKGROUND

A spoil ground is a storage site for waste soil and rock generated from earth-rock excavation, tunnel development, and other activities during engineering construction, usually included by loosely accumulated earth-rock mixtures. This slope is characterized by loose structure, low shear strength, and easy deformation, and stability of the slopes is relatively poor. Meanwhile, formation and evolution processes of spoil ground slopes are complex and affected by multiple factors, including rainfall, maintenance status of drainage facilities, earthquakes, and human activities. Therefore, stability monitoring of these slopes is particularly important.

In the related art, when data obtained from monitoring data is processed and analyzed, it is possible to encounter unbalanced distribution of different types of data. Under normal working conditions (that is, non-earthquake, extreme disaster, war and other special working conditions), most slopes are stable, and the collected data of stable slope is often far more than that of unstable slope. These data, when used for the prediction training of slope stability models, will cause the trained models to pay more attention to the data of the dominant stable slopes, thereby leading the models to tend to determine the slopes as stable during prediction. Some slopes with poor stability may also be misdetermined as stable. Serious potential safety hazards to the lives and property of people downstream are brought by such misdeterminations. To solve this problem, the present disclosure provides a slope stability monitoring system for spoil grounds.

### SUMMARY

An objective of the present disclosure is to provide a slope stability monitoring system for spoil grounds to solve the problem that a prediction result of a slope stability prediction model is inaccurate because stable slope data is far more than unstable slope data in the related art.

To achieve the above objective, the present disclosure adopts the following technical solutions.

The present disclosure provides to a slope stability monitoring system for spoil grounds, including:
a data collection module: responsible for collecting deformation data of a slope in real time through various sensors (such as a displacement sensor, a stress sensor, an inclination sensor, etc.) deployed on the slope of a spoil ground, and acquiring macro information of the slope using aerial images and digital elevation images; and
a data transmission module: responsible for transmitting the collected data to a data processing center in real time using the Internet of Things (IoT) technology, including wired transmission and wireless transmission to ensure the real-time and reliability of the data, in which
the data processing center includes a data processing and analysis module, an early warning and decision support module and a user interaction module;
the data processing and analysis module: responsible for processing and analyzing the transmitted data, evaluating the stability state of the slope by constructing a slope stability model, and generating some new and virtual unstable slope data through generative adversarial network (GAN) to supplement a training set based on known unstable slope features in a construction of the slope stability model;
the early warning and decision support module: responsible for setting an early warning threshold, comparing an output result of the slope stability model with the early warning threshold, automatically triggering an early warning mechanism once the output result exceeds the threshold, sending early warning information to relevant personnel through the user interaction module, providing decision support function at the same time, and providing a basis for slope reinforcement and treatment; and
the user interaction module: responsible for providing operation interface and visual display function; and viewing slope monitoring data, stability evaluation results, early warning information and decision support by users in real time through an operation interface.

In further technical solutions:

Furthermore, in the data collection module, a horizontal displacement and a vertical displacement of the slope are monitored by a displacement sensor to understand the overall deformation of the slope; a stress sensor monitors the stress distribution inside the slope to help determine whether the slope is in a stress balance state, and if the stress distribution is abnormal, it indicates that the slope is about to lose stability; and combined with the macro information and deformation data of the slope, the stability of the slope is comprehensively evaluated. For example, if the overall shape of the slope is steep, the slope is large, and the geological structure is complex, its stability may be poor. On the contrary, if the overall shape of the slope is gentle, the slope is moderate and the geological structure is simple, its stability may be better.

Furthermore, the data processing and analysis module includes a data receiving unit, a data preprocessing unit, a data augmentation unit, a feature extraction unit, a model training and optimization unit, and a stability evaluation unit; the data receiving unit is responsible for receiving slope deformation data and slope macro information transmitted from the data transmission module, performing preprocessing operations including cleaning, denoising and filtering on the received data to improve the accuracy and reliability of the data, and transferring the processed data to the subsequent feature extraction unit or data augmentation unit; the data augmentation unit is responsible for generating new virtual data using GAN based on known unstable slope features, receiving data from the data preprocessing unit, and transferring generated virtual data to the model training unit; the feature extraction unit is responsible for extracting feature information using principal component analysis (PCA), receiving data from the data preprocessing unit, and transferring extracted features to the model training unit; the model training and optimization unit is responsible for training and optimization using the received features and virtual data, and outputting a trained slope stability model; and the stability evaluation unit is responsible for evaluating the stability of new slope deformation data using the trained slope stability model.

Furthermore, the data augmentation unit is responsible for generating new virtual data using GAN, and including the steps of:
data collection: collecting existing processed slope feature data, including geological structure, topography, rainfall, and soil moisture;
feature extraction: extracting key features related to slope stability from the preprocessed data which may include slope, height, soil type, and groundwater level of the slope;
GAN model training: constructing a GAN model, including a generator and a discriminator, in which a task of the generator is to generate virtual data similar to real data, a task of the discriminator is to distinguish real data from virtual data, and through training, the generator generates virtual data that is closer to real data; and
virtual data generation: generating new virtual data using a trained generator based on known unstable slope features.

Furthermore, the key features related to the slope stability are screened out by correlation analysis, and the Pearson correlation coefficient between each feature and the slope stability is calculated, and a formula of the Pearson correlation coefficient is:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}}$$

where xᵢ and yᵢ are an eigenvalue and a slope stability value of an i-th sample, x̅ and y̅ are mean values of the eigenvalues and slope stability value, and n is the number of samples;
according to a value of Pearson correlation coefficient, the degree of correlation between each feature and slope stability is explained, and the larger an absolute value of Pearson correlation coefficient, the higher the degree of correlation between the feature and the slope stability; when |r|~1, it indicates a strong linear relationship between the feature and the slope stability, and when |r|~0, it indicates that there is almost no linear relationship between the feature and the slope stability.

Further, the GAN model training includes specific steps of:
GAN model construction: generator: designing a neural network structure whose input is a random noise vector and an output is virtual data similar to the real slope feature data; and discriminator: the other neural network structure whose input is real data or virtual data generated by the generator, and an output is a probability that the data is real data;
loss function definition: generator loss: measuring a difference between the virtual data generated by the generator and the real data, with a generator loss function being L_{G}=−E_{z~p}_{_{z}}_{(z)} [log D(G(z))], where z represents a random noise vector, G(z) represents the virtual data generated by the generator, and D(G(z)) represents a prediction probability of the discriminator on the virtual data generated by the generator; and discriminator loss: measuring an ability of the discriminator to distinguish real data from virtual data, with a discriminator loss function being L_{D}=−E_{x~p}_{_{z}}_{(z)} [log D(x)]−E_{z~p}_{_{z}}_{(z)} [log(1−D(G(z)], where x represents the real data, and D(x) represents a prediction probability of the discriminator on the real data; and
training process: initializing model parameters: assigning random weights to the generator and discriminator; iterative training: discriminator training: training the discriminator using the real data and virtual data generated by the generator to distinguish the two accurately; generator training: training the generator using feedback from the discriminator to make the generated virtual data closer to the real data; and weights updating: after each iteration, updating weights of the generator and discriminator based on gradients of the loss function; and continuously optimizing the weights of the generator and discriminator through an iterative training process, and allowing the generator to produce virtual data that becomes more similar to real data.

Furthermore, the feature extraction unit uses PCA to extract feature information, and sets the processed data as M slope samples {X¹, X², . . . , X^{M},}, each slope sample has N-dimensional slope features

$${X}^{i} = {( {X}_{1}^{i} , {X}_{2}^{i} , … , {X}_{N}^{i} )}^{T} ,$$

and each slope feature Xⱼ has its own slope feature value;
firstly, all slope features are centralized (i.e., mean-subtracted); specifically, a mean value of each slope feature is calculated, for all slope samples, each slope feature is subtracted by its own mean value, and respective mean values are

$$\overline{{X}_{1}} = \frac{1}{M} {\sum }_{i = 1}^{M} {X}_{1}^{i} , \overline{{X}_{2}} = \frac{1}{M} {\sum }_{i = 1}^{M} {X}_{2}^{i} , … , \overline{{X}_{N}} = \frac{1}{M} {\sum }_{i = 1}^{M} {X}_{N}^{i} ;$$

and after centralization, a covariance matrix

$$C = [ \begin{matrix}cov ( {X}_{1} , {X}_{1} ) & cov ( {X}_{1} , {X}_{2} ) \\ cov ( {X}_{2} , {X}_{1} ) & cov ( {X}_{2} , {X}_{2} )\end{matrix} ]$$

is calculated, diagonal elements represent variances of slope features X₁ and X₂, while off-diagonal elements represent covariances, a formula for cov(X₁,X₁) is

$$cov ( {X}_{1} , {X}_{1} ) = \frac{{\sum }_{i = 1}^{M} ( {X}_{1}^{i} - \overline{{X}_{1}} ) ( {X}_{1}^{i} - \overline{{X}_{1}} )}{M - 1} ,$$

and a covariance matrix C of M slope samples under N-dimensional slope features is obtained; and
after obtaining the covariance matrix, the eigenvalues and corresponding eigenvectors are calculated according to a feature equation Cμ=Aμ, where λ is the eigenvalue and μ is the corresponding eigenvector; the top k largest eigenvalues and corresponding eigenvectors are selected for projection, the projection is a dimensionality reduction process, which reduces an original high-dimensional slope features to low dimensions, after dimensionality reduction, a large amount of redundant information is removed, at least 85% of the original information is retained, and the processed slope features are transmitted to the model training unit.

Furthermore, the model training and optimization unit performs training and optimization using the received features and virtual data, and outputs the trained slope stability model, and including the steps of:
model selection: selecting an attention mechanism model based on Transformer as the slope stability model according to data features and task requirements of slope stability monitoring in spoil grounds;
parameters initialization: randomly initializing parameters including weight and bias of the model;
data preparation: inputting preprocessed features and virtual data as well as actual observation values of slope stability into the model;
loss function definition: selecting the mean square error as a loss function, with a mean square error formula being

$$MSE = \frac{1}{n} {\sum }_{i = 1}^{n} {( {y}_{i} - {\hat{y}}_{i} )}^{2}$$

where yᵢ, is an actual observation value, ŷᵢ is a model prediction value, and n is the number of samples;
optimization algorithm selection: performing iterative training using Adam optimization algorithm;
iterative training: calculating the loss by forward propagation, updating model parameters by back propagation, and repeating this process until the loss function converges or reaches a preset number of iterations;
model evaluation: evaluating the performance of the model using a validation set, and using an accuracy rate as an evaluation index;
model tuning: adjusting hyper-parameters of the model or improving the model structure to improve the prediction accuracy of the model according to evaluation results; for example, increasing the number of layers of attention mechanism or adjust a learning rate to further optimize the performance of the model;
model preservation: preserving the trained slope stability model to a specified path or database, and preserved contents include parameters such as weight and offset of the model and structural information of the model; and
model deployment: deploying the trained slope stability model into the stability evaluation unit.

The present disclosure has the following beneficial effects.

In the present disclosure, based on the known unstable slope features, some new and virtual unstable slope data are generated by GAN to supplement the training set. The new and virtual unstable slope data can supplement the shortcomings of real data, and enable the model to contact more slope features during training to ensure data balance. This helps the model to learn a more comprehensive feature representation, thus improving the accuracy of prediction.

### BRIEF DESCRIPTION OF THE DRAWINGS

FIG. 1 is a system architecture diagram of a slope stability monitoring system for spoil grounds provided by the present disclosure.

### DETAILED DESCRIPTION

Technical solutions in the examples of the present disclosure will be described clearly and completely in the following with reference to the accompanying drawings in the examples of the present disclosure. Obviously, all the described examples are only some, rather than all examples of the present disclosure. Based on the examples in the present disclosure, all other examples obtained by those ordinary skilled in the art without creative efforts belong to the scope of protection of the present disclosure.

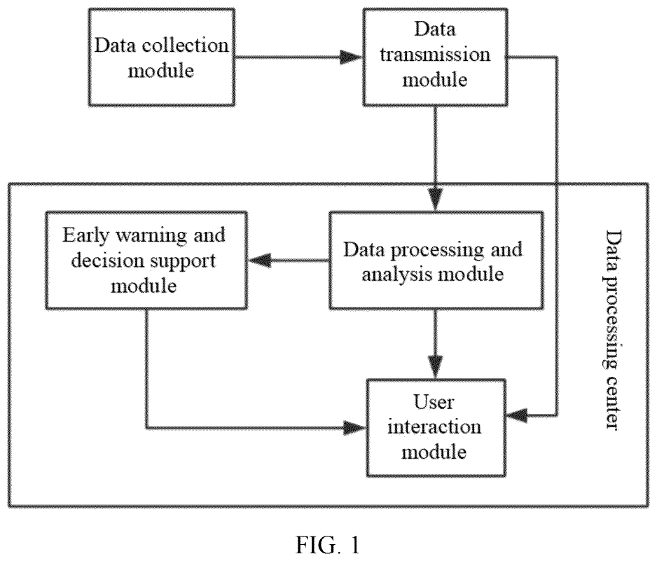

As shown in FIG. 1, a slope stability monitoring system for spoil grounds includes a data collection module and a data transmission module.

The data collection module is responsible for collecting deformation data of a slope in real time through various sensors (such as a displacement sensor, a stress sensor, an inclination sensor, etc.) deployed on the slope of a spoil ground, and acquiring macro information of the slope using aerial images and digital elevation images.

The data transmission module is responsible for transmitting the collected data to a data processing center in real time using the IoT technology, including wired transmission and wireless transmission to ensure the real-time and reliability of the data.

The data processing center includes a data processing and analysis module, an early warning and decision support module and a user interaction module.

The data processing and analysis module is responsible for processing and analyzing the transmitted data, evaluating the stability state of the slope by constructing a slope stability model, and generating some new and virtual unstable slope data through GAN to supplement a training set based on known unstable slope features in a construction of the slope stability model.

The early warning and decision support module is responsible for setting an early warning threshold, comparing an output result of the slope stability model with the early warning threshold, automatically triggering an early warning mechanism once the output result exceeds the threshold, sending early warning information to relevant personnel through the user interaction module, providing decision support function at the same time, and providing a basis for slope reinforcement and treatment.

The user interaction module is responsible for providing operation interface and visual display function; and viewing slope monitoring data, stability evaluation results, early warning information and decision support by users in real time through an operation interface.

In one example, in the data collection module, a horizontal displacement and a vertical displacement of the slope are monitored by a displacement sensor to understand the overall deformation of the slope; a stress sensor monitors the stress distribution inside the slope to help determine whether the slope is in a stress balance state, and if the stress distribution is abnormal, it indicates that the slope is about to lose stability; and combined with the macro information and deformation data of the slope, the stability of the slope is comprehensively evaluated. For example, if the overall shape of the slope is steep, the slope is large, and the geological structure is complex, its stability may be poor. On the contrary, if the overall shape of the slope is gentle, the slope is moderate and the geological structure is simple, its stability may be better.

In one example, the data processing and analysis module includes a data receiving unit, a data preprocessing unit, a data augmentation unit, a feature extraction unit, a model training and optimization unit, and a stability evaluation unit; the data receiving unit is responsible for receiving slope deformation data and slope macro information transmitted from the data transmission module, performing preprocessing operations including cleaning, denoising and filtering on the received data to improve the accuracy and reliability of the data, and transferring the processed data to the subsequent feature extraction unit or data augmentation unit; the data augmentation unit is responsible for generating new virtual data using GAN based on known unstable slope features, receiving data from the data preprocessing unit, and transferring generated virtual data to the model training unit; the feature extraction unit is responsible for extracting feature information using PCA, receiving data from the data preprocessing unit, and transferring extracted features to the model training unit; the model training and optimization unit is responsible for training and optimization using the received features and virtual data, and outputting a trained slope stability model; and the stability evaluation unit is responsible for evaluating the stability of new slope deformation data using the trained slope stability model.

In one example, the data augmentation unit is responsible for generating new virtual data using GAN, and including the following steps.

Data collection: existing processed slope feature data, including geological structure, topography, rainfall, and soil moisture, are collected.

Feature extraction: key features related to slope stability are extracted from the preprocessed data, which may include slope, height, soil type, and groundwater level of the slope.

GAN model training: a GAN model, including a generator and a discriminator, is constructed. The task of the generator is to generate virtual data similar to real data, and the task of the discriminator is to distinguish real data from virtual data. Through training, virtual data that is closer to real data is generated by the generator.

Virtual data generation: new virtual data is generated using a trained generator based on known unstable slope features.

In one example, the key features related to the slope stability are screened out by correlation analysis, and the Pearson correlation coefficient between each feature and the slope stability is calculated, and a formula of the Pearson correlation coefficient is:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}}$$

where xᵢ and yᵢ are an eigenvalue and a slope stability value of an i-th sample, x̅ and y̅ are mean values of the eigenvalues and slope stability value, and n is the number of samples;
according to a value of Pearson correlation coefficient, the degree of correlation between each feature and slope stability is explained, and the larger an absolute value of Pearson correlation coefficient, the higher the degree of correlation between the feature and the slope stability; when |r|~1, it indicates a strong linear relationship between the feature and the slope stability, and when |r|~0, it indicates that there is almost no linear relationship between the feature and the slope stability.

In one example, the GAN model training includes the following specific steps.

GAN model construction: generator: a neural network structure is designed, whose input is a random noise vector and output is virtual data similar to the real slope feature data. The other neural network structure (discriminator) is designed, whose input is real data or virtual data generated by the generator, and output is a probability that the data is real data.

Loss function definition: generator loss: a difference between the virtual data generated by the generator and the real data is measured, with a generator loss function being L_{G}=−E_{z~p}_{_{z}}_{(z)}[log D(G(z))], where z represents a random noise vector, G(z) represents the virtual data generated by the generator, and D(G(z)) represents a prediction probability of the discriminator on the virtual data generated by the generator. Discriminator loss: an ability of the discriminator to distinguish real data from virtual data is measured as discriminator loss, with a discriminator loss function being L_{D}=−E_{x~p}_{_{data}}_{(z)} [log D(x)]−E_{z~p}_{_{z}}_{(z)} [log(1−D(G(z)))], where x represents the real data, and D(x) represents a prediction probability of the discriminator on the real data.

Training process: model parameters initialization: random weights are assigned to the generator and discriminator. Iterative training: discriminator training: the discriminator is trained using the real data and virtual data generated by the generator to distinguish the two accurately; generator training: the generator is trained using feedback from the discriminator to make the generated virtual data closer to the real data; and weights updating: after each iteration, the weights of the generator and discriminator are updated based on gradients of the loss function. The weights of the generator and discriminator are continuously optimized through an iterative training process, and the generator is allowed to produce virtual data that becomes more similar to real data.

In one example, the feature extraction unit uses PCA to extract feature information, and sets the processed data as M slope samples {X¹, X², . . . , X^{M},}, each slope sample has N-dimensional slope features

$${X}^{i} = {( {X}_{1}^{i} , {X}_{2}^{i} , … , {X}_{N}^{i} )}^{T} ,$$

and each slope feature Xⱼ has its own slope feature value.

Firstly, all slope features are centralized (i.e., mean-subtracted); specifically, a mean value of each slope feature is calculated, for all slope samples, each slope feature is subtracted by its own mean value, and respective mean values are

$$\overline{{X}_{1}} = \frac{1}{M} {\sum }_{i = 1}^{M} {X}_{1}^{i} , \overline{{X}_{2}} = \frac{1}{M} {\sum }_{i = 1}^{M} {X}_{2}^{i} , … , \overline{{X}_{N}} = \frac{1}{M} {\sum }_{i = 1}^{M} {X}_{N}^{i} ;$$

and after centralization, a covariance matrix

$$C = [ \begin{matrix}cov ( {X}_{1} , {X}_{1} ) & cov ( {X}_{1} , {X}_{2} ) \\ cov ( {X}_{2} , {X}_{1} ) & cov ( {X}_{2} , {X}_{2} )\end{matrix} ]$$

is calculated, diagonal elements represent variances of slope features X₁ and X₂, while off-diagonal elements represent covariances, a formula for cov(X₁,X₁) is

$$cov ( {X}_{1} , {X}_{1} ) = \frac{{\sum }_{i = 1}^{M} ( {X}_{1}^{i} - \overline{{X}_{1}} ) ( {X}_{1}^{i} - \overline{{X}_{1}} )}{M - 1} ,$$

and a covariance matrix C of M slope samples under N-dimensional slope features is obtained.

After obtaining the covariance matrix, the eigenvalues and corresponding eigenvectors are calculated according to a feature equation Cμ=Aμ, where λ is the eigenvalue and μ is the corresponding eigenvector; the top k largest eigenvalues and corresponding eigenvectors are selected for projection, the projection is a dimensionality reduction process, which reduces an original high-dimensional slope features to low dimensions, after dimensionality reduction, a large amount of redundant information is removed, at least 85% of the original information is retained, and the processed slope features are transmitted to the model training unit.

In one example, the model training and optimization unit performs training and optimization using the received features and virtual data, and outputs the trained slope stability model, and including the following steps.

Model selection: an attention mechanism model based on Transformer is selected as the slope stability model according to data features and task requirements of slope stability monitoring in spoil grounds.

Parameters initialization: parameters including weight and bias of the model are randomly initialized.

Data preparation: preprocessed features, virtual data, and actual observation values of slope stability are input into the model.

Loss function definition: the mean square error is selected as a loss function, with a mean square error formula being

$$MSE = \frac{1}{n} {\sum }_{i = 1}^{n} {( {y}_{i} - {\hat{y}}_{i} )}^{2}$$

where yᵢ is an actual observation value, ŷᵢ is a model prediction value, and n is the number of samples.

Optimization algorithm selection: iterative training is performed using Adam optimization algorithm.

Iterative training: the loss is calculated through forward propagation, model parameters are updated through back propagation, and this process is repeated until the loss function converges or the preset number of iterations is reached.

Model evaluation: the performance of the model is evaluated using a validation set, and an accuracy rate is used as an evaluation index.

Model tuning: hyper-parameters of the model are adjusted or the model structure is improved to enhance the prediction accuracy of the model according to evaluation results. For example, the number of layers of the attention mechanism is increased or the learning rate is adjusted to further optimize the performance of the model.

Model preservation: the trained slope stability model is preserved to a specified path or database, and the preserved contents include parameters such as weight and bias of the model as well as structural information of the model.

Model deployment: the trained slope stability model is deployed into the stability evaluation unit.

While examples of the present disclosure have been illustrated and described, those ordinary skilled in the art will understand that various changes, modifications, substitutions and variations can be made to these examples without departing from the principles and spirit of the present disclosure. The scope of the present disclosure is limited to the appended claims and equivalents thereof.

1. A slope stability monitoring system for spoil grounds, comprising:
a data collection module: responsible for collecting deformation data of a slope in real time through various sensors deployed on the slope of a spoil ground, and acquiring macro information of the slope using aerial images and digital elevation images; and
a data transmission module: responsible for transmitting the collected data to a data processing center in real time using the Internet of Things (IoT) technology, comprising wired transmission and wireless transmission, wherein
the data processing center comprises a data processing and analysis module, an early warning and decision support module and a user interaction module;
the data processing and analysis module: responsible for processing and analyzing the transmitted data, evaluating the stability state of the slope by constructing a slope stability model, and generating some new and virtual unstable slope data through generative adversarial network (GAN) to supplement a training set based on known unstable slope features in a construction of the slope stability model;
the early warning and decision support module: responsible for setting an early warning threshold, comparing an output result of the slope stability model with the early warning threshold, automatically triggering an early warning mechanism once the output result exceeds the threshold, sending early warning information to relevant personnel through the user interaction module, providing decision support function at the same time, and providing a basis for slope reinforcement and treatment; and
the user interaction module: responsible for providing operation interface and visual display function; and viewing slope monitoring data, stability evaluation results, early warning information and decision support by users in real time through an operation interface.

2. The slope stability monitoring system for spoil grounds according to claim 1, wherein in the data collection module, a horizontal displacement and a vertical displacement of the slope are monitored by a displacement sensor to understand the overall deformation of the slope; a stress sensor monitors the stress distribution inside the slope to help determine whether the slope is in a stress balance state, and if the stress distribution is abnormal, it indicates that the slope is about to lose stability; and combined with the macro information and deformation data of the slope, the stability of the slope is comprehensively evaluated.

3. The slope stability monitoring system for spoil grounds according to claim 1, wherein the data processing and analysis module comprises a data receiving unit, a data preprocessing unit, a data augmentation unit, a feature extraction unit, a model training and optimization unit, and a stability evaluation unit; the data receiving unit is responsible for receiving slope deformation data and slope macro information transmitted from the data transmission module, performing preprocessing operations on the received data, and transferring the processed data to the subsequent feature extraction unit or data augmentation unit; the data augmentation unit is responsible for generating new virtual data using GAN based on known unstable slope features, receiving data from the data preprocessing unit, and transferring generated virtual data to the model training unit; the feature extraction unit is responsible for extracting feature information using principal component analysis (PCA), receiving data from the data preprocessing unit, and transferring extracted features to the model training unit; the model training and optimization unit is responsible for training and optimization using the received features and virtual data, and outputting a trained slope stability model; and the stability evaluation unit is responsible for evaluating the stability of new slope deformation data using the trained slope stability model.

4. The slope stability monitoring system for spoil grounds according to claim 3, wherein the data augmentation unit is responsible for generating new virtual data using GAN, comprising the steps of:
data collection: collecting existing processed slope feature data;
feature extraction: extracting key features related to slope stability from the preprocessed data;
GAN model training: constructing a GAN model, comprising a generator and a discriminator, wherein a task of the generator is to generate virtual data similar to real data, a task of the discriminator is to distinguish real data from virtual data, and through training, the generator generates virtual data that is closer to real data; and
virtual data generation: generating new virtual data using a trained generator based on known unstable slope features.

5. The slope stability monitoring system of the waste yard according to claim 4, wherein the key features related to the slope stability are screened out by correlation analysis, and the Pearson correlation coefficient between each feature and the slope stability is calculated, and a formula of the Pearson correlation coefficient is:
$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}}$$
where xᵢ and yᵢ are an eigenvalue and a slope stability value of an i-th sample, x̅ and y̅ are mean values of the eigenvalues and slope stability value, and n is the number of samples;
according to a value of Pearson correlation coefficient, the degree of correlation between each feature and slope stability is explained, and the larger an absolute value of Pearson correlation coefficient, the higher the degree of correlation between the feature and the slope stability; when |r|≈1, it indicates a strong linear relationship between the feature and the slope stability, and when |r|≈0, it indicates that there is almost no linear relationship between the feature and the slope stability.

6. The slope stability monitoring system for spoil grounds according to claim 4, wherein the GAN model training comprises specific steps of:
GAN model construction: generator: designing a neural network structure whose input is a random noise vector and an output is virtual data similar to the real slope feature data; and discriminator: the other neural network structure whose input is real data or virtual data generated by the generator, and an output is a probability that the data is real data;
loss function definition: generator loss: measuring a difference between the virtual data generated by the generator and the real data, with a generator loss function being L_{G}=−E_{z~p}_{_{z}}_{(z)}[log D(G(z))], where z represents a random noise vector, G(z) represents the virtual data generated by the generator, and D(G(z)) represents a prediction probability of the discriminator on the virtual data generated by the generator; and discriminator loss: measuring an ability of the discriminator to distinguish real data from virtual data, with a discriminator loss function being L_{D}=−E_{x~p}_{_{data}}_{(z)}[log D(x)]—E_{z~p}_{_{z}}_{(z)}[log(1−D(G(z)))], where x represents the real data, and D (x) represents a prediction probability of the discriminator on the real data; and
training process: initializing model parameters: assigning random weights to the generator and discriminator; iterative training: discriminator training: training the discriminator using the real data and virtual data generated by the generator to distinguish the two accurately; generator training: training the generator using feedback from the discriminator to make the generated virtual data closer to the real data; and weights updating: after each iteration, updating weights of the generator and discriminator based on gradients of the loss function; and continuously optimizing the weights of the generator and discriminator through an iterative training process, and allowing the generator to produce virtual data that becomes more similar to real data.

7. The slope stability monitoring system for spoil grounds according to claim 3, wherein the feature extraction unit uses PCA to extract feature information, and sets the processed data as M slope samples {X¹, X², . . . , X^{M},}, each slope sample has N-dimensional slope features
$${X}^{i} = {( {X}_{1}^{i} , {X}_{2}^{i} , … , {X}_{N}^{i} )}^{T} ,$$
each slope feature Xⱼ has its own slope feature value;
firstly, all slope features are centralized (i.e., mean-subtracted); specifically, a mean value of each slope feature is calculated, for all slope samples, each slope feature is subtracted by its own mean value, and respective mean values are
$$\overline{{X}_{1}} = \frac{1}{M} {\sum }_{i = 1}^{M} {X}_{1}^{i} , \overline{{X}_{2}} = \frac{1}{M} {\sum }_{i = 1}^{M} {X}_{2}^{i} , … , \overline{{X}_{N}} = \frac{1}{M} {\sum }_{i = 1}^{M} {X}_{N}^{i} ;$$
and after centralization, a covariance matrix
$$C = [ \begin{matrix}cov ( {X}_{1} , {X}_{1} ) & cov ( {X}_{1} , {X}_{2} ) \\ cov ( {X}_{2} , {X}_{1} ) & cov ( {X}_{2} , {X}_{2} )\end{matrix} ]$$
is calculated, diagonal elements represent variances of slope features X₁ and X₂, while off-diagonal elements represent covariances, a formula for cov(X₁,X₁) is
$$cov ( {X}_{1} , {X}_{1} ) = \frac{{\sum }_{i = 1}^{M} ( {X}_{1}^{i} - \overline{{X}_{1}} ) ( {X}_{1}^{i} - \overline{{X}_{1}} )}{M - 1} ,$$
and a covariance matrix C of M slope samples under N-dimensional slope features is obtained; and
after obtaining the covariance matrix, the eigenvalues and corresponding eigenvectors are calculated according to a feature equation Cμ−Aμ, where λ is the eigenvalue and μ is the corresponding eigenvector; the top k largest eigenvalues and corresponding eigenvectors are selected for projection, the projection is a dimensionality reduction process, which reduces an original high-dimensional slope features to low dimensions, after dimensionality reduction, a large amount of redundant information is removed, at least 85% of the original information is retained, and the processed slope features are transmitted to the model training unit.

8. The waste slag yard slope stability monitoring system according to claim 3, wherein the model training and optimization unit performs training and optimization using the received features and virtual data, and outputs the trained slope stability model, comprising the steps of:
model selection: selecting an attention mechanism model based on Transformer as the slope stability model according to data features and task requirements of slope stability monitoring in spoil grounds;
parameters initialization: randomly initializing parameters comprising weight and bias of the model;
data preparation: inputting preprocessed features and virtual data as well as actual observation values of slope stability into the model;
loss function definition: selecting the mean square error as a loss function, with a mean square error formula being
$$MSE = \frac{1}{n} {\sum }_{i = 1}^{n} {( {y}_{i} - {\hat{y}}_{i} )}^{2}$$
where yᵢ is an actual observation value, ŷᵢ is a model prediction value, and n is the number of samples;
optimization algorithm selection: performing iterative training using Adam optimization algorithm;
iterative training: calculating the loss by forward propagation, updating model parameters by back propagation, and repeating this process until the loss function converges or reaches a preset number of iterations;
model evaluation: evaluating the performance of the model using a validation set, and using an accuracy rate as an evaluation index;
model tuning: adjusting hyper-parameters of the model or improving the model structure according to evaluation results;
model preservation: preserving the trained slope stability model to a specified path or database, and preserved contents comprise parameters such as weight and offset of the model and structural information of the model; and
model deployment: deploying the trained slope stability model into the stability evaluation unit.
